(19) United States
(12) Patent Application Publication
(10) Pub. No.: US 2001/0056494 A1
(43) Pub. Date: Dec. 27, 2001

(54) Device and method for controlling access to resources

(76) Inventor: Hatem Trabelsi, Chaville (FR)

Correspondence Address: Miles & Stockbridge P. C., Suite 500, 1751 Pinnacle Drive, McLean, VA, 22102-3833, US

(21) Appl. No.: 09/740,800

(22) Filed: Mar. 9, 2001

(30) Foreign Application Priority Data
Dec. 21, 1999 (FR) FR 99 16117

(51) Int. Cl. G06F 15/16

(52) U.S. Cl. 709/229

(57) ABSTRACT

The present invention relates to a method for controlling access by a requestor (7) to resources (2d) in a computer system (1), consisting of defining roles that overlay one or more privileges and representing the requestor's authorization to perform specific tasks, of storing the defined roles in storage means (10, 12), and of storing an access control list that defines the conditions for obtaining a right to a resource type, i.e., a configured permission, in terms of privileges in said means (10, 12).

The present invention also relates to the device for implementing said method.

The present invention relates to a device and a method for control resources in a computer system.

### THE PRIOR ART

Computer systems having a very large number of geographically distributed resources require many administrators to manage them. Each administrator owns rights to execute privileged commands on given resources.

One problem posed by the invention is that of controlling the administrator's rights in a computer system and preventing those who have not received the appropriate authorization from performing actions on given resources.

Moreover, the number of resources in a computer system increases rapidly. Because of this, access control becomes complex, given the large amount of information to be handled.

Currently, in order to respond to such problems, computer systems comprise, at the level of each managed resource, an access control list specifying the rights of identified administrators or groups of administrators to perform a given action on the resource in question. The rights of the administrators or groups of administrators are specified resource by resource. A list of the rights associated with a resource is stored in a file associated with said resource. When an application launched by a given administrator wants to access a resource, the system consults the list that is attached to said resource and verifies whether said administrator has the right to access it.

A system of this type is based on the identity of the administrator, and the more the number of administrators increases, the more complex the system becomes, and the slower and more expensive it becomes. Furthermore, the system needs to access the interrogated resource even if the calling administrator does not have the appropriate rights required to do so and the administrator's request is ultimately denied. This results in a long response time.

One object of the present invention consists of simplifying the method for controlling access to the resources of a system.

Another object of the invention is to avoid having to systematically access the resources interrogated in order to verify the rights of the caller and authorize access to said resources.

### SUMMARY OF THE INVENTION

In this context, the present invention offers a method for controlling access by a requestor to resources in a computer system, characterized in that it consists of defining roles that overlay one or more privileges and represent the requestor's authorization to perform specific tasks, of storing the defined roles in storage means, and of storing an access control list that defines the conditions for obtaining a right to a type of resource, i.e. a configured permission, in terms of privileges in said means.

The present invention also relates to the system for implementing said method.

### PRESENTATION OF THE FIGURES

Other characteristics and advantages of the invention will become clear in light of the following description, given as an illustrative and non-limiting example of the present invention, in reference to the attached drawings in which:

FIG. 1 is a schematic view of an embodiment of the system according to the invention;

FIG. 2 represents an embodiment of the list represented in FIG. 1;

FIG. 3 is an example of the list represented in FIG. 2;

FIG. 4 is a table of exemplary generic groups of rights and resources.

### DESCRIPTION OF AN EMBODIMENT OF THE INVENTION

The computer system can be a system whose environment is distributed or local.

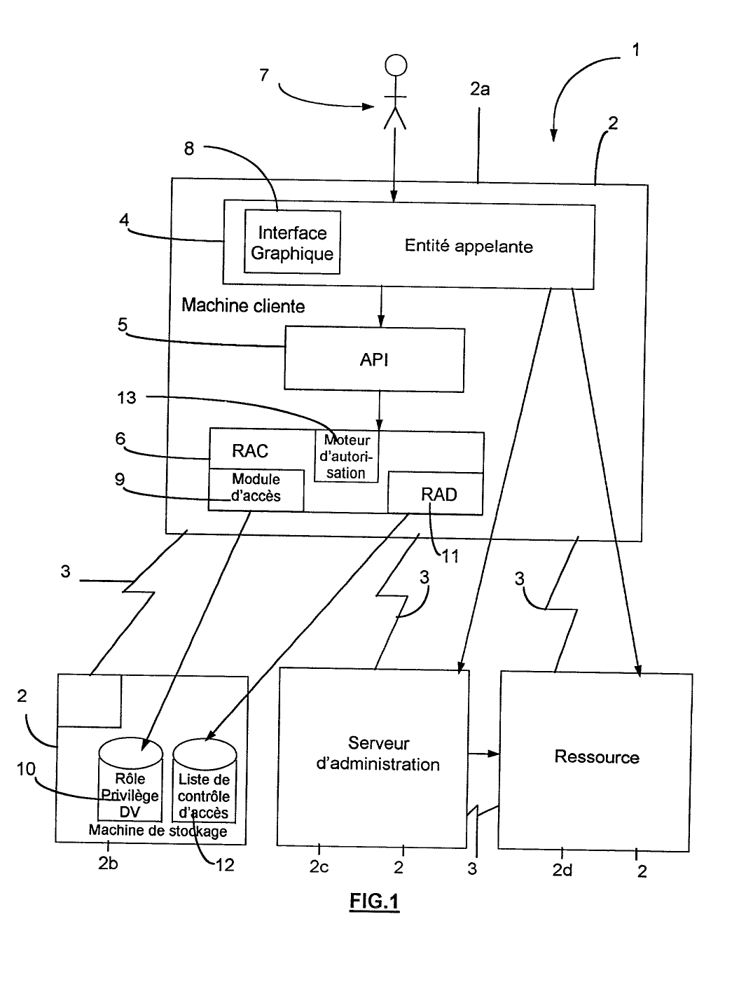

As shown in the embodiment of the system according to the invention illustrated in FIG. 1, the computer system 1 is distributed and composed of machines 2a, 2b, 2c, 2d organized into one or more networks 3. A machine 2 is a very broad conceptual unit that includes both hardware and software. The machines can be very diverse, such as workstations, servers, routers, specialized machines and gateways between networks. Only the components of the machines 2 of the system 1 that are characteristic of the present invention will be described, the other components being known to one skilled in the art.

As shown in FIG. 1, in the present invention, the computer system 1 comprises at least one machine 2a called a client machine 2a, at least one centralized secure storage machine 2b, at least one management server 2c, and at least one managed resource machine 2d. It should be noted that the machines 2 can be combined with one another; thus, for example, the storage machine 2b and the management server 2c could form only one machine.

The resource 2d is intended in the broad sense, i.e. any logical and/or physical entity accessed and manipulated by client machines 2a. The resource can exist, for example, in the form of a printer, a file, etc. The resource 2d in the example described is characterized by a type, and possibly by an identifier. A resource type contains a set of rights that apply to all the resources of this type. The identifier is constituted, for example, by a name, an access path, etc.

For example, the resource 2d is a printer of the “network printer” type, whose identifier is the path of the resource “\\mao.dom\bleuet.” In another example, the resource 2d is a Louveciennes billing database of the “database” type, whose identifier is the name of the database “database_facturation.frlv.bull.fr”. The “database” type contains, for example, the following rights: “start”, “stop”, “configure”, etc.

An access control criterion is a property of the resource 2d used to control access to this resource. The criterion uniquely identifies a particular resource or set of resources. The properties of the resource that can be used as criteria are, for example, the type of the resource, the path, or a combination of the two.

The client machine 2a comprises at least one calling entity 4, an application program interface (API) 5, an access control service 6 (called RAC). The calling entity 4, the API 5 and the RAC 6 can belong to just one machine 2 or to different machines 2.

The calling entity 4 hereinafter represents any logical and/or physical entity performing a set of procedures and operations that can require access to one or more resources 2d. The calling entity 4 can exist, for example, in the form of an application, a file, or a command.

A requester 7 launches the calling entity 4 and requests authorization to perform an action in the context of this entity 4 on a resource 2d. The requestor 7 is a physical person, and in the embodiment illustrated, an administrator. In the example illustrated, the calling entity 4 exists in the form of an application and the resource 2d is a database; the client machine 2a handles the question of whether the administrator 7 working in said application 4 has the right to perform an action on a database 2d. The requester can only access said resource 2d if he has adequate rights.

A right designates one or more actions or commands executed by a requester 7, in the context of a calling entity 4, on a resource 2d or a set of resources 2d. For a requestor 7, the right is either global or specific to a resource 2d, and in the latter case, it defines a particular type of access to the resource 2d in question. For example, in the database context, an administrator may have the right to stop or start particular databases depending on his role and his administrative privileges.

The calling entity 4 receives from requesters 7 requests to access resources 2d. According to a particular embodiment, the calling entity 4 offers the requester 7 a graphical interface 8 through which the requester 7 enters his request. The API 5 transmits the interrogation from the calling entity 4 to the RAC 6. The API 5 forms the interface between the calling entity 4 and the RAC 6 with which it is associated. The RAC 6 controls the access of the requesters 7 to the interrogated resources 2d.

The API 5 specifically offers functions for accessing the RAC, particularly in order to make a decision in response to the question posed by the calling entity 4.

The RAC 6, as shown in FIG. 1, includes three functional modules:

a module 9 for accessing storage means 10, and more particularly in the present embodiment, means 10 for storing the requestor's roles, privileges and validity domains, which will be defined below;

a module 11 for accessing storage means 12, and more particularly in the present embodiment, means 12 for storing requestor access control lists, making it possible to load access control lists existing in the form of files, or other storage means; the module 11 is hereinafter called the RAD.

an authorization engine 13.

The system according to the present invention is based on a particular characteristic of the requesters 7, i.e. their role in the enterprise, and more particularly (in the example illustrated) in the management of the enterprise's computer systems. In order to define a requestor's role, it is first necessary to explain what is meant by a privilege.

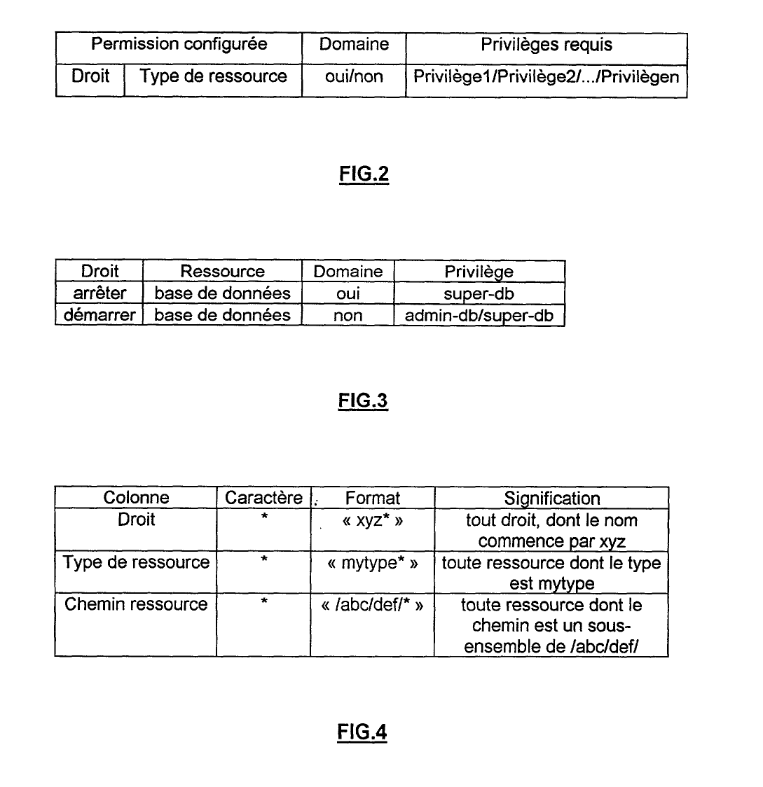

A privilege is a security attribute of a requestor 7 that makes it possible to control the latter's access to resources 2d. Each resource has its own list of privileges; it is also possible to provide lists of privileges common to several resources or to the entire system. The privilege is assigned to a requester directly or indirectly through a role. For example, an administrator can be assigned the database administrator privilege “admin_db”, a privilege that allows him to start any type of database (FIG. 3).

A role is constituted by a set of privileges; it covers a job connotation and represents an authorization to perform a set of activities and administrative tasks. Thus, for example, the requestor “Dupont” has the role (job) of administrator of the billing application; at the system level, the requester “Dupont,” given his role as administrator of the billing application, has the privileges “database administrator”(“admin_db”), “super_db”, “network operator”, “remote software installer”, and “system operator”.

The set of privileges in a given role serves as the basis for controlling a requestor's actions. A requestor is assigned one or more roles. The requester 7 defines new roles or modifies existing roles by adding or deleting privileges.

The access control lists stored in the storage means 12 define the conditions for obtaining access rights to resources attached to the entities 4 that manage them; they offer an interface based on configured permissions.

A permission is an association of a resource with a right. For example, a permission can be for stopping (right) a particular database (resource). The permission represents a type of access, an action or a particular operation in the context of a calling entity 4 or of a resource 2d of the calling entity 4 in question.

There are two types of permissions: requested permissions and configured permissions.

Requested permissions are questions posed by a calling entity 4 to the RAC 6. The responses to these questions allow the calling entities 4 to know whether an access right should be authorized for the requestor in the current utilization context of the entity.

Configured permissions define an access mode possible in one or more resources, as seen above. The configured permissions are stored in the list 12.

The conditions for obtaining permissions are expressed in the form of combinations of privileges.

The lists of permissions and conditions for obtaining these permissions are constituted by rows, called entries. FIG. 2 represents an entry on a list. The entry expresses the configured permissions and the conditions for obtaining a right to a resource in terms of the privileges required. The entry comprises three columns: a right column, a resource column, the right and resource columns forming the configured permission, and a privilege column. According to an exemplary embodiment of the invention, the resource is identified by its type; the type is the access control criterion.

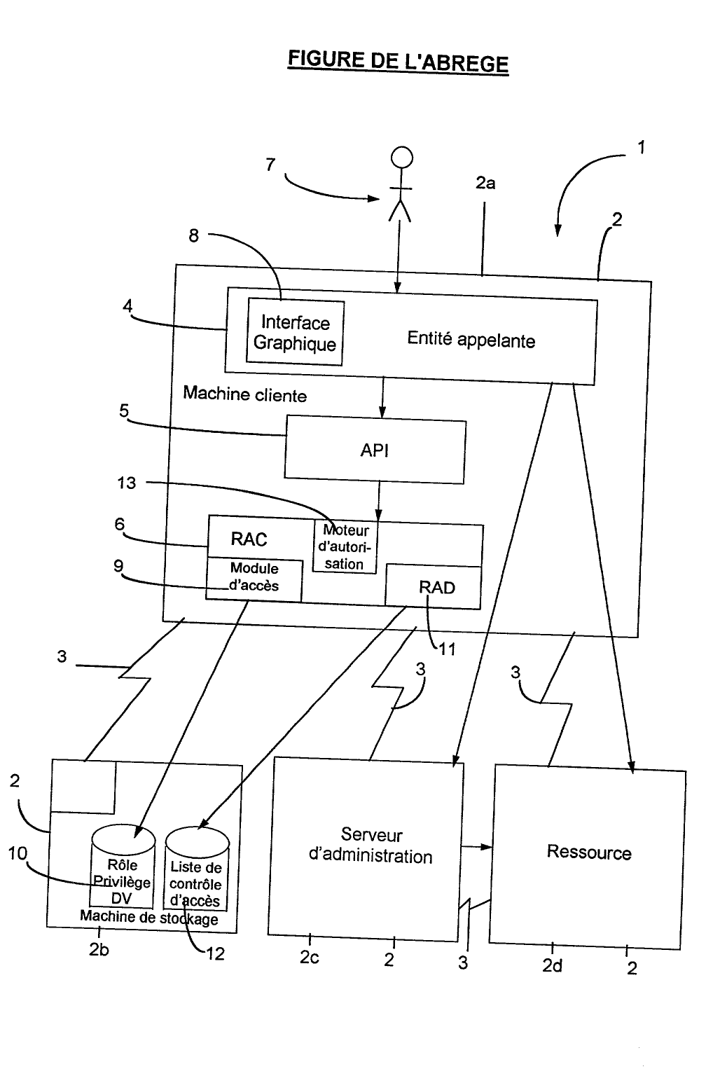

The rights or the resources can be grouped into generic groups represented by filters in the form of special characters such as a star “*”or by keywords such as the word “any”. The keyword “any” indicates, for example, any privilege. The table of FIG. 4 indicates exemplary meanings of the star filter. The “star” filter applied to a right with the format “xyz*” means any right whose name begins with xyz. The “star” filter applied to a resource type with the format “mytype*” means any resource whose type is mytype. The “star” filter applied to a resource path “/abc/def/*” means any resource whose path is a subpath of /abc/def/.

The filters and keywords make it possible to combine a large number of entries into one, and in this way to facilitate the management of the configuration.

In the embodiment described, an entry in the list represents authorized accesses. According to one development of the invention, an entry also contains negative permissions.

The system according to the present invention makes it possible to restrict the resources accessible for a given role to only part of the global set of resources 2d by means of a validity domain of a role. A validity domain defines a part of a set of resources 2d that is accessible for a given role. If the instances of the resources are organized hierarchically in a tree, a collection of resource branches determines a validity domain.

An additional piece of information relative to the need to consult the validity domain is provided in the entry of the list in order to avoid the systematic comparison of the domain with the path of the resource in question. The comparison is not necessary when the validity domain corresponds to the path of the resource. The information in question consists in a boolean (yes-no) expressing whether or not there is a need to consult the validity domain.

FIG. 3 represents an access control list that includes the fields relative to the need to consult the validity domain; this field is named Domain. In order for an administrator who has the privilege super_db to stop the database, the RAC must verify that the path of the resource corresponds to the validity domain, which is not the case if the administrator wishes to start the database. In the latter case, the administrator can start any database without restriction.

The RAC 6 assigns a default value to the unfilled fields of an entry on the list.

According to an illustrative embodiment of the invention, the default values are:

For the resource type: * (any resource type: a right associated with the resource type * indicates that the right applies to any resource type);

For the right: * (any right: a right * associated with a resource indicates that any right applies to said resource);

For the domain: yes;

For the privileges required: any (no privilege is required for the right requested).

A requestor's security data is constituted by one or more roles associated with one or more privileges, and optionally with a validity domain of the role.

A requestor's security data is distinguished from the access control list, in which the conditions for obtaining a right to a resource are described in terms of the privileges required and in terms of whether or not there is a need to consult the validity domain of the role. The security data is stored in the storage means 10 and the access control list is stored in the storage means 12.

The system according to the present invention works in the following way.

When the requestor 7 launches the calling entity 4, he selects an administrative role from those offered by the graphical interface 8 until he disconnects from said entity 4. In the example used throughout the following description, the requester “Dupont” is an administrator who selects the role administrator of the billing application.

The requestor 7 asks to perform an action on a given resource. For example, the administrator Dupont wishes to stop the Louveciennes billing database whose name is “database_facturation.frlv.bull.fr”.

When the calling entity 4 must decide to authorize or deny an action by the requestor 7 on a given resource 2d, it poses the question to the API 5 on the basis of the requestor's identity. The calling entity 4 requests a permission from the API 5, which constitutes a requested permission (as seen above).

The calling entity 4 submits to the API 5, for example, the following question:

“Does the administrator Dupont have the right to stop the Louveciennes billing database resource whose name is “database_facturation.frlv.bull.fr”?

Upon receipt of said question and upon the first call from the API 5, the RAC 6 searches for the role and the list of privileges of the requester 7 via the module 9 for accessing privileges. In the example, the requestor 7 specifically has the role “database administrator” and the associated privileges “super_db” and admin_db”. The role “database administrator” has as its validity domain the databases whose names end in frlv.bull.fr, i.e. “*.frlv.bull.fr”.

The method performs checks on two levels, the second of which is conditional relative to the first:

a first level on the type of the resource;

a second level on the identifier of the resource.

During the first-level check, the RAC 6 consults the access control list (FIG. 2) via the RAD 11. An extract from this list according to the example illustrated is given in FIG. 3. The authorization engine 13 of the RAC 6 verifies there is that at least one entry on the list that satisfies the conditions for obtaining the requested right, i.e., that contains the following three elements: said resource, the requested right, and at least one of the requestor's privileges.

If the conditions for obtaining the right are not satisfied, i.e. if no entry on the list contains the required three elements, the RAC 6 via the API 5 responds negatively to the question from the calling entity 4. The calling entity 4 indicates to the requester 7 that he does not have the right to perform the requested action on the resource in question, in this case, to stop the Louveciennes billing database.

It must be emphasized that the requestor is informed that he cannot perform a given action on a given resource prior to any access to this resource.

If the conditions for obtaining the right are satisfied, i.e., if one or more entries on the list simultaneously contain the required three elements, and if in addition the validity domain in the entry or entries in question has the value “no,” no additional check is required. All of the resources in question are accessible for the given role. The RAC, via the API, responds positively to the question from the calling entity 4. The calling entity 4 authorizes the requestor 7 to perform the requested action, in this case to stop the Louveciennes billing database.

If the conditions for obtaining the right are satisfied, i.e. if one or more entries on the list simultaneously contain the required three elements, and if in addition the validity domain in the entry or entries in question has the value “yes”, the method moves to the second-level check. This is the case in the example used: the first entry on the list of FIG. 3 satisfies the conditions for obtaining the right requested by the administrator: the right is the right to stop, the resource type is a database, and the requested privilege is super_db.

In the second-level check, in order to determine whether the role in question can perform the requested action on said resource, the authorization engine 13 performs a check on the validity domain associated with the current role if the following three conditions coexist:

the requested permission contains a resource identifier (name, path); in essence, if the requester wants to start a database, the response can only be negative, no database having been specified. On the other hand, if the requester wants to start the Louveciennes billing database, a response may be provided, depending on the role and the privileges of the requester;

there is at least one configured permission that corresponds to the requested permission; the RAC uses the access control criterion to identify a resource in order to perform the comparison of the requested permissions and the configured permissions;

the validity domain consultation field has the value yes, which means that it is necessary to verify the validity domain, the action being restricted to a subset of the total resources. When a validity domain is associated with a role and the validity domain consultation field has the value yes, any requestor having this role can only access or act on resources in the validity domain.

If all three conditions exist, the RAC 6 compares the identifier of the resource in the question posed to the validity domain of the role found in the storage means 10 by the module 9 as seen above.

If the validity domain does not correspond to the resource in question, the conditions for obtaining the right are not fulfilled, and the RAC 6 responds to the calling entity 4 via the API 5, indicating that the user does not have the right to perform the requested action.

If the validity domain does correspond to the resource in question, the conditions for obtaining the right are fulfilled and the RAC 6 responds to the calling entity 4 via the API 5, indicating that the user has the right to perform the requested action.

In the example of the description, the method compares the Louveciennes billing database resource whose name is “database_facturation.frlv.bull.fr”to the validity domain of the database administrator role, which is constituted by the databases whose names end in frlv.bull.fr, i.e. “*.frlv.bull.fr”. The Louveciennes billing database resource has a name that ends in frlv.bull.fr; it therefore belongs to the validity domain. The calling entity 4 authorizes the administrator 7 to stop the Louveciennes billing database.

It must be emphasized that:

the permissions are independent of the requesters; permissions are granted or denied based on the role and the privileges of the requester;

the access control does not require physical access to the resources; a filtering of the actions is performed prior to any access;

the access control device is fast. Moreover, the device and the method according to the invention offer an optimization of access control.

The present invention relates to the method for controlling access by the requestor 7 to resources 2d in the computer system 1, characterized in that it consists of defining roles that overlay one or more privileges and represent the requestor's authorization to perform specific tasks, of storing the defined roles in the storage means 10, 12, and of storing the access control list that defines the conditions for obtaining a right to a resource type, i.e. a configured permission, in terms of privileges in said means 10, 12.

The method controls access by the requestor 7 to resources 2d without accessing said resources 2d.

The method performs an access check on two levels:

a first level on the type of the resource 2d;

a second level on the identifier of the resource 2d.

The method consists of:

identifying the requestor as well as his role and his privileges;

comparing the privileges and the permissions requested by the requestor with the required privileges and configured permissions stored in the storage means 10; and

authorizing the requested action on the resource in question when the requested and configured permissions match and when one of the required privileges corresponds to the privilege of the entity.

The method consists of restricting the resources accessible for a given role to only part of the resources, by means of a validity domain, and of storing the validity domains constituted in the storage means 10.

The method consists of consulting a piece of information stored in the storage means 10 relative to the need to consult the validity domain, and of verifying that the resource in question belongs to the validity domain only if said information requires it.

The method consists of grouping the rights or resources into generic groups represented by special characters or keywords or other symbols.

The present invention also concerns the device capable of implementing the method described above.

The present invention relates to the device for controlling access by a requestor to resources 2d in the computer system 1, characterized in that it comprises the management machine 2a comprising the access control service, the RAC 6 and the means for storing 10 roles, privileges and access control lists.

1. Method for controlling access by a requester (7) to resources (2d) in a computer system (1) in which the requester is assigned one or more roles based on an access control list that defines the conditions for obtaining a right to a resource, characterized in that it consists of restricting the resources accessible for a given role to only part of the resources, by means of a validity domain of the role.

2. Method according to claim 1, characterized in that it stores an additional piece of information relative to the need to consult the validity domain of the role in the access control list.

3. Method according to claim 2, characterized in that it consults the additional information relative to the need to consult the validity domain of the role and verifies that the resource in question belongs to the validity domain only if said information requires it.

4. Method according to claim 2, characterized in that it performs an access check on two levels:
a first level on the type of the resource (2d);
a second level on the identifier of the resource (2d).

5. Method according to claim 4, characterized in that it performs a first-level check verifying the existence of at least one entry of the access control list that satisfies the conditions for obtaining the requested right, and if the entry exists, the existence of a validity domain for said entry.

6. Method according to claim 5, characterized in that it performs a second-level check verifying, if the requested permission contains a resource identifier, the existence of at least one configured permission corresponding to the requested permission, and the value of the additional information relative to the need to consult the validity domain.

7. Method according to any of claims 1 through 5, characterized in that it consists of grouping rights or resources into generic groups represented by special characters or keywords or other symbols.

8. Device for controlling access by a requester to resources (2d) in a computer system (1), characterized in that it comprises a management machine (2a) comprising an access control service, the RAC (6), and means for storing (10) roles, access control lists and validity domains

9. Device for implementing the method according to any of claims 1 through 6.

10. Software module for implementing the method according to any of claims 1 through 6.
